(19) United States
(12) Patent Application Publication
(10) Pub. No.: US 2024/0073287 A1
(43) Pub. Date: Feb. 29, 2024

(54) METHOD FOR ACTIVATING EDGE SERVERS

(71) Applicant: Lenovo (Beijing) Limited, Beijing (CN)

(72) Inventors: Ming LEI, Beijing (CN); Haijun XU, Beijing (CN); Zhipeng GAO, Beijing (CN); Da LI, Beijing (CN); Shaohua LI, Beijing (CN)

(21) Appl. No.: 18/240,634

(22) Filed: Aug. 31, 2023

(30) Foreign Application Priority Data
Aug. 31, 2022 (CN) 202211065882.0

(51) Int. Cl. H04L 67/141; H04L 9/30; H04L 9/32; H04L 67/10

(52) U.S. Cl. CPC H04L 67/141; H04L 9/30; H04L 9/3213; H04L 67/10

(57) ABSTRACT

Embodiments of the present disclosure provide a method for activating at least a first edge server and a second edge server. The first edge server includes a first service processor, and the second edge server includes a second service processor. The method includes establishing a data communication connection between the first service processor and the second service processor, establishing a data communication connection between the first service processor and a specified website, establishing a trusted communication between the first service processor and the specified website, establishing a trusted communication between the first service processor and the second service processor, obtaining an activation right from the specified website by the first service processor, and performing the activation right to activate the first edge server and the second edge server by the first service processor.

### CROSS-REFERENCE TO RELATED APPLICATION

The present disclosure claims priority to Chinese Patent Application No. 202211065882.0, filed on Aug. 31, 2022, the entire content of which is incorporated herein by reference.

### TECHNICAL FIELD

The present disclosure relates to the method for activating a plurality of edge servers and, more particularly, to a method for activating the plurality of edge servers in a same local network.

### BACKGROUND

More and more edge servers are deployed on the market. However, since an environment using an edge server is relatively fragile, the edge server is normally in a locked state during transportation. Thus, the edge server needs to be activated for use.

For many clients, activating the edge server is inconvenient, because a general edge station cannot be directly connected to a relevant website (e.g., Lenovo ThinkShield Portal) through a mobile network (e.g., Internet), and activation functions provided by the relevant website cannot be used. Thus, some clients need to use a mobile phone application to activate the edge server, and some other clients need to activate the edge server manually. However, no matter activating the edger server by using the mobile phone application or manually, the edge servers need to be activated one by one, which is time-consuming and labor-intensive.

Therefore, the purpose of the present disclosure is to provide a method for activating at least two edge servers and a multi-server system to eliminate the above problem and provide a replacement solution.

### SUMMARY

Embodiments of the present disclosure provide a method for activating at least a first edge server and a second edge server. The first edge server includes a first service processor, and the second edge server includes a second service processor. The method includes establishing a data communication connection between the first service processor and the second service processor, establishing a data communication connection between the first service processor and a specified website, establishing a trusted communication between the first service processor and the specified website, establishing a trusted communication between the first service processor and the second service processor, obtaining an activation right from the specified website by the first service processor, and performing the activation right to activate the first edge server and the second edge server by the first service processor.

Embodiments of the present disclosure provide a multi-server system, including a first edge server and a second edge server. The first edge server includes a first service processor. The second edge server includes a second service processor. The first service processor and the second service processor are mutually connected for data communication. The first service processor is mutually connected to a specified website for data communication. The first service processor established a trusted communication with the specified website. The first service processor and the second service processor establish a trusted communication therebetween. The first service processor obtains an activation right from the specified website. The first service processor performs the activation right to activate the first edge server and the second edge server.

### BRIEF DESCRIPTION OF THE DRAWINGS

FIG. 1 illustrates a schematic diagram of a method for activating at least two edge servers according to some embodiments of the present disclosure.

FIG. 2 illustrates a schematic diagram showing a part of a method for activating at least two edge servers according to some embodiments of the present disclosure.

### DETAILED DESCRIPTION OF THE EMBODIMENTS

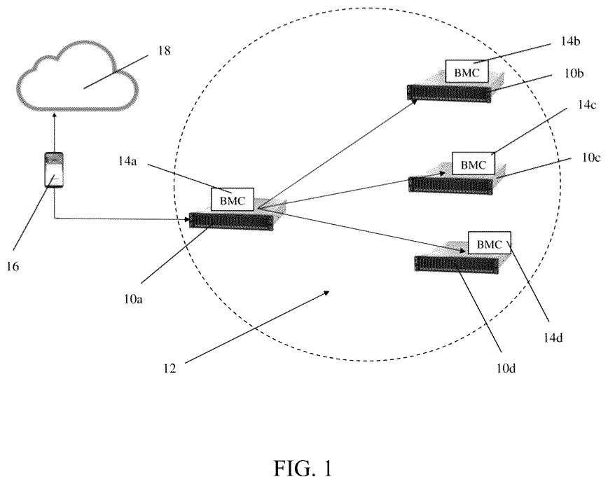

FIG. 1 illustrates a schematic diagram of a method for activating at least two edge servers according to some embodiments of the present disclosure. A plurality of edge servers 10a, 10b, 10c, and 10d form a multi-server system 12. Each edge server of the plurality of edge servers 10a, 10b, 10c, and 10d includes a service processor, for example, a baseboard management controller (BMC) of a plurality of BMCs 14a, 14b, 14c, and 14d. Assume that the edge servers 10a, 10b, 10c, and 10d are not activated, the BMCs 14a, 14b, 14c, and 14d then need to be interconnected for data communication first.

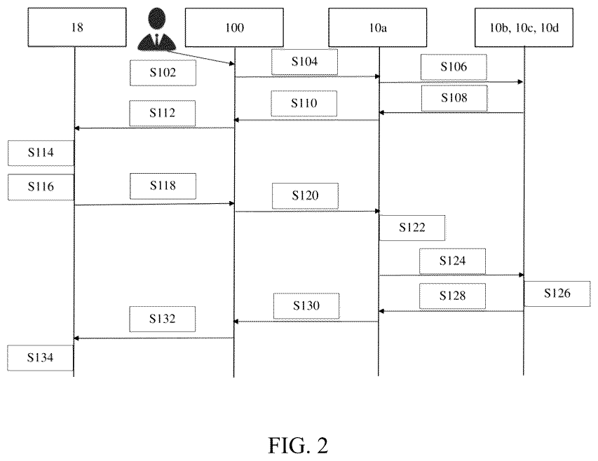

If the edge servers 10a, 10b, 10c, and 10d each have a wireless network module, the BMCs 14a, 14b, 14c, and 14d can start wireless network modules to search for predefined wireless network hotspots, for example, Lenovo_Edge_Activation. Meanwhile, one edge server 10a is interconnected to a mobile phone 16 for data communication. The mobile phone 16 is data-communicated with a mobile network (e.g., Internet). Thus, the edge server 10a can communicate data with at least one specified website 18 (e.g., ThinkShield Portal) on the mobile network (e.g., Internet) through the mobile phone 16. Furthermore, by executing a mobile phone application 100 shown in FIG. 2 on the mobile phone 16, the edge server 10a can be connected to the specified website 18 for data communication.

In addition, if the edge server 10a includes a Long Term Evolution (LTE) hardware module connected to the BMC 14a of the edge server 10a, the edge server 10a can be also connected to a mobile cellular network for data communication through the LTE hardware module. Thus, the edge server 10a can be connected to the specified website 18 for data communication.

After the edge server 10a is connected to the specified website 18 for data communication through the mobile phone application 100, the edge server 10a can be changed into a wireless network hotspot, which can be named with a predefined name (e.g., Lenovo_Edge_Activation), and the password of the wireless network hotspot can be a public key of the specified website 18. Other edge servers 10b, 10c, and 10d in the same local network of the edge station can be also connected to the wireless network hotspot. Thus, the BMCs 14a, 14b, 14c, and 14d of the edge servers 10a, 10b, 10c, and 10d can be interconnected for data communication.

If the edge servers 10a, 10b, 10c, and 10d do not include a wireless network module but each includes an internal switch module, the clients/users can connect the edge servers 10a, 10b, 10c, and 10d with each other in a daisy chain form to enable data communication to allow the BMCs 14a, 14b, 14c, and 14d of the edge servers 10a, 10b, 10c, and 10d to communicate with each other.

The internal switch modules of the edge servers 10a, 10b, 10c, and 10d can be connected to the BMCs 14a, 14b, 14c, and 14d of the edge servers 10a, 10b, 10c, and 10d, respectively. A port of each internal switch module can be connected to a port of an internal switch module of a next edge server so as to mutually connect the edge servers 10a, 10b, 10c, and 10d to cause the BMCs 14a, 14b, 14c, and 14d to communicate with each other.

If the edge servers 10a, 10b, 10c, and 10d do not include a wireless network module and an internal switch module, the edge servers 10a, 10b, 10c, and 10d can be mutually connected for data communication through an external switch module. Thus, the BMCs 14a, 14b, 14c, and 14d of the edge servers 10a, 10b, 10c, and 10d can communicate with each other. The external switch module can be connected to the BMCs 14a, 14b, 14c, and 14d of the edge servers 10a, 10b, 10c, and 10d. Thus, the BMCs 14a, 14b, 14c, and 14d can communicate with each other.

After the edge servers 10a, 10b, 10c, and 10d are connected to cause the BMCs 14a, 14b, 14c, and 14d of the edge servers 10a, 10b, 10c, and 10d to communicate with each other and the edge server 10a to be connected to the specified website 18 for data communication, the edge server 10a can send an unauthenticated Representational State Transfer Application Programming Interface (REST API) to other edge servers 10b, 10c, and 10d in the same local network to obtain basic information of the edge servers 10b, 10c, and 10d, e.g., at least one of system name, machine type, or serial number, or other information.

After the BMCs 14a, 14b, 14c, and 14d of the edge servers 10a, 10b, 10c, and 10d are mutually connected, the edge server 10a can automatically discover the other edge servers 10b, 10c, and 10d. Then, the mobile phone 16 connected to the edge server 10a can display all the edge servers 10a, 10b, 10c, and 10d. If a certain edge server is not listed on the screen of the mobile phone 16 running the mobile phone application 100, a problem with the network connection to the edge server can be indicated. Thus, detection and correction may need to be performed.

The edge server 10a can send the basic information of the other edge servers 10b, 10c, and 10d to the mobile phone 16. The mobile phone application 100 running on the mobile phone 16 can list all the edge servers 10a, 10b, 10c, and 10d to allow the clients/users to confirm whether all the edge servers 10a, 10b, 10c, and 10d need to be activated simultaneously.

As shown in FIG. 2, after the clients/users confirm that all the edge servers 10a, 10b, 10c, and 10d or some of the edge servers 10a, 10b, 10c, and 10d need to be activated simultaneously through the mobile phone application 100 running on the mobile phone 16 (S102), the mobile phone application 100 can send one or more pieces of specified basic information of the edge servers 10a, 10b, 10c, and 10d and authentication information of the BMC 14a to the specified website 18 to request the specified website 18 to provide tokens for the edge servers 10a, 10b, 10c, and 10d.

Although using the mobile phone 16 and the mobile phone application 100 is convenient, another method can be technically used. For example, a special-purpose device can be connected to the BMC 14a through an interface at a front panel of the edge server 10a. Meanwhile, the device can be connected to the cellular network. Then, the device can be used for activation too.

The request of the tokens to the specified website 18 is based on the cascaded connection of the one or more pieces of basic information of the edge servers 10a, 10b, 10c, and 10d and the authentication information of the BMC 14a (i.e., a signature for signing the basic information of the edge server 10a using a private key of the BMC 14a).

After the specified website 18 receives the request of providing the tokens, the basic information of the edge servers 10a, 10b, 10c, and 10d can be compared and verified with related information stored in an information database. If a verification result is positive, the specified website 18 can verify the authentication information of the BMC 14a using the private key of the BMC 14a stored in the website information database. If a verification result is positive, the specified website 18 can generate a token for each of the edge servers 10a, 10b, 10c, and 10d. After passing the verification process above, the BMC 14a can establish a trusted communication with the specified website 18.

The token can include the basic information of each of edge servers 10a, 10b, 10c, and 10d and a public key of the BMC 14a and can be signed using the private key of the specified website 18.

The token obtained by the BMC 14a from the specified website 18 can be used to establish the trusted communication between the BMC 14a and the BMC 14b, 14c, and 14d of the edge servers 10b, 10c, and 10d. The trust can be established based on the verification of the BMC 14a by the specified website 18 through the mobile phone application 100 running on the mobile phone 16. Moreover, the trust can be further established based on the token signed by the private key of the specified website 18 by the BMC 14a from the specified website 18. Since the edge servers 10a, 10b, 10c, and 10d store the public key of the specified website 18 after being manufactured and before transferring the edge servers 10a, 10b, 10c, and 10d, the edge servers 10b, 10c, and 10d can perform verification on the token to determine whether the BMC 14a can be trusted. Meanwhile, since the token can also store the public key of the BMC 14a, the edge servers 10b, 10c, and 10d can perform verification on the authentication of the BMC 14a to allow the BMC 14a to perform verification in subsequent steps.

By providing the token, by the BMC 14a, to the BMC 14b, 14c, and 14a of the edge servers 10b, 10c, and 10d, the verification result can be positive. After the trusted communication is established between the BMC 14a and the BMCs 14b, 14c, and 14d of the edge servers 10b, 10c, and 10d, the mobile phone application 100 can require the BMC 14a to provide activation request codes of the edge servers 10a, 10b, 10c, and 10d, respectively (S104).

Based on the token, the BMC 14a of the edge server 10a can require the edger servers 10b, 10c, and 10d to provide activation request codes of their own (S106). Based on the trust, the edge servers 10b, 10c, and 10d can send the activation request codes to the BMC 14a of the edge server 10a. Then, the BMC 14a of the edge server 10a can provide the activation request codes of the edge servers 10a, 10b, 10c, and 10d to the mobile phone application 100 (S110).

The mobile phone application 100 can provide the activation request codes of the edge servers 10a, 10b, 10c, and 10d to the specified website 18 and request the specified website 18 to provide corresponding activation responses (S112). The specified website 18 can first verify the activation request codes of the edge servers 10a, 10b, 10c, and 10d (S114). After obtaining the positive verification result, the specified website 18 can generate the activation responses for the edge servers 10a, 10b, 10c, and 10d (S116). Then, the specified website 18 can send the activation responses of the edge servers 10a, 10b, 10c, and 10d to the mobile phone application 100 (S118). Then, the activation responses can be sent to the edge server 10a (S120). The activation responses can represent activation rights or activation indications for the edge servers 10a, 10b, 10c, and 10d.

After receiving the activation responses of the edge servers 10a, 10b, 10c, and 10d, the BMC 14a of the edge server 10a can first verify the activation response of the edge server 10a to activate the edger server 10a (S122). Then, other activation responses can be sent to the BMCs 14b, 14c, and 14d of the edge servers 10b, 10c, and 10d. After the BMCs 14b, 14c, and 14d of the edge servers 10b, 10c, and 10d receive the corresponding activation responses and verify the activation responses, respectively, the edge servers 10b, 10c, and 10d can be activated.

After the edge servers 10b, 10c, and 10d are activated, activation results can be sent to the edge server 10a (S128). The edge server 10a can send a report of the activation results of the edge servers 10a, 10b, 10c, and 10d to the mobile phone application 100 (S130). Then, the report can be sent to the specified website 18 (S132). After receiving the activation results of the edge servers 10a, 10b, 10c, and 10d, the specified website 18 can update the activation states of the edge servers 10a, 10b, 10c, and 10d (S134).

As described above, the multi-server system 12 of the present disclosure can include the edge servers 10a, 10b, 10c, and 10d. Each edge server of the edge servers 10a, 10b, 10c, and 10d includes one BMC of the BMCs 14a, 14b, 14c, and 14d. The BMCs 14a, 14b, 14c, and 14d can be mutually connected for data communication, or at least each of the BMCs 14b, 14c, and 14d can be mutually connected to the BMC 14a for data communication. The BMCs 14b, 14c, and 14d can also be mutually connected for data communication. The BMC 14a can be connected to the specified website 18 for data communication through the mobile phone application 100 running on the mobile phone 16. Based on this, the multi-server system 12 can be suitable to perform the method for activating the edge servers 10a, 10b, 10c, and 10d.

The above are only embodiments of the present disclosure. Modifications and/or changes can be made to embodiments of the present disclosure without departing from the spirit of the present disclosure. For brevity, features of embodiments of the present disclosure can be provided separately or in any suitable sub-combination.

What is claimed is:

1. A method for activating a first edge server and a second edge server, wherein the first edge server includes a first service processor, and the second edge server includes a second service processor, the method comprising:
establishing a data communication connection between the first service processor and the second service processor;
establishing a data communication connection between the first service processor and a specified website;
establishing a trusted communication between the first service processor and the specified website;
establishing a trusted communication between the first service processor and the second service processor;
obtaining an activation right from the specified website by the first service processor; and
executing the activation right to activate the first edge server and the second edge server by the first service processor.

2. The method according to claim 1, wherein the first service processor is connected to the specified website for data communication through a mobile phone being able to communicate data with a mobile network.

3. The method according to claim 1, wherein establishing the trusted communication between the first service processor and the specified website includes:
providing authentication information of the first service processor and at least one piece of basic information of the second edge server to the specified website by the first service processor.

4. The method according to claim 3, wherein the authentication information of the first service processor and the at least one piece of basic information of the second edge server are encrypted with a private key of the first service processor.

5. The method according to claim 3, wherein:
the specified website verifies the authentication information of the first service processor and the at least one piece of basic information of the second edge server provided by the first service processor, and provides a token to the first service processor when a verification result is positive; and
in establishing the trusted communication between the first service processor and the second service processor, the first service processor provides the token to the second service processor.

6. The method according to claim 1, wherein:
the first service processor requests the second service processor to provide an activation request code of the second edge server; and
the first service processor provides an activation request code of the first edge server and the activation request code of the second edge server to the specified website.

7. The method according to claim 6, wherein:
after the specified website verifies the activation request code of the first edge server and the activation request code of the second edge server provided by the first service processor, the specified website provides an activation response for the first edge server and an activation response for the second edge server to the first service processor; and
after the first service processor receives the activation response of the first edge server and the activation response of the second edge server, the first service processor activates the first edge server and sends the activation response of the second edge server to the second service processor.

8. The method according to claim 1, wherein:
the first edge server and the second edge server each include a wireless network module or an internal switch module; and
the first service processor and the second service processor are mutually connected for data communication through the wireless network module or the internal switch module.

9. The method according to claim 1, wherein:
the first edge server and the second edge server are mutually connected to an external switcher for data communication; and
the first service processor and the second service processor are mutually connected for data communication through the external switcher.

10. A multi-server system comprising:
a first edge server including a first service processor; and
a second edge server including a second service processor;
wherein:
the first service processor and the second service processor are mutually connected for data communication;
the first service processor is mutually connected to a specified website for data communication;
the first service processor established a trusted communication with the specified web site;
the first service processor and the second service processor establish a trusted communication therebetween;
the first service processor obtains an activation right from the specified website; and
the first service processor executes the activation right to activate the first edge server and the second edge server.

11. The system according to claim 10, wherein the first service processor is connected to the specified website for data communication through a mobile phone being able to communicate data with a mobile network.

12. The system according to claim 10, wherein the first service processor provides authentication information of the first service processor and at least one piece of basic information of the second edge server to the specified website.

13. The system according to claim 12, wherein the first service processor performs encryption on the authentication information of the first service processor and the at least one piece of basic information of the second edge server with a private key of the first service processor.

14. The system according to claim 12, wherein the first service processor provides a token obtained from the specified website to the second service processor.

15. The system according to claim 10, wherein:
the first service processor requests the second service processor to provide an activation request code of the second edge server; and
the first service processor provides an activation request code of the first edge server and the activation request code of the second edge server to the specified website.

16. The system according to claim 15, wherein:
after the first service processor receives an activation response of the first edge server and an activation response of the second edge server, the first service processor activates the first edge server and sends the activation response of the second edge server to the second service processor.

17. The system according to claim 10, wherein:
the first edge server and the second edge server each includes a wireless network module or an internal switch module, and the first edge server and the second edge server are mutually connected for data communication through the wireless network modules.

18. The system according to claim 10, wherein:
the first edge server and the second edge server are mutually connected to an external switcher for data communication, and the first edge server and the second edge server are mutually connected for data communication through the external switcher.
